(19) United States
(12) Patent Application Publication
(10) Pub. No.: US 2024/0289732 A1
(43) Pub. Date: Aug. 29, 2024

(54) METHOD, APPARATUS, DEVICE AND STORAGE MEDIUM FOR DELIVERY COST ESTIMATION

(71) Applicants: Beijing Youzhuju Network Technology Co., Ltd., Beijing (CN); Lemon Inc., Grand Cayman (KY)

(72) Inventors: Shuang Liang, Beijing (CN); Haiyuan Sun, Beijing (CN); Kuo Pang, Singapore (SG)

(21) Appl. No.: 18/588,735

(22) Filed: Feb. 27, 2024

(30) Foreign Application Priority Data
Feb. 27, 2023 (CN) 202310211316.4

(51) Int. Cl. G06Q 10/0834; G06Q 30/0601

(52) U.S. Cl. CPC G06Q 10/08345; G06Q 30/0631

(57) ABSTRACT

According to embodiments of the present disclosure, method, apparatus, device, and storage medium for delivery cost estimation are provided. The method comprises: extracting first feature information specific to a target recommended content item from related data of the target recommended content item, and the target recommended content item is to be delivered to recommend target resources; at least based on the first feature information, using a trained cost estimation model, determining an expected initial cost in a contending delivery of the target recommended content item; and determining a target initial cost used in the contending delivery of the target recommended content item based on the expected initial cost. According to the solution, the initial cost of each recommended content item during contending delivery can be accurately estimated specifically to improve delivery performance.

### CROSS-REFERENCE

The present application claims priority to Chinese Patent Application No. 202310211316.4, filed on Feb. 27, 2023 and entitled “METHOD, APPARATUS, DEVICE AND STORAGE MEDIUM FOR DELIVERY COST ESTIMATION”, the entirety of which is incorporated herein by reference.

### FIELD

The disclosed example embodiments relate generally to the field of computer technology, and, more particularly, to a method, apparatus, device and computer readable storage medium for delivery cost estimation.

### BACKGROUND

Internet provides access to a variety of resources. For example, various applications, products, and audio and video content, etc. can be accessed through the Internet. In addition, the accessible content also includes specific recommended content items related to various objects/resources, these content items such as including advertisements. Resource providers with resources can provide content delivery providers with delivery about recommended content items. The delivery of recommended content items can be based on contention. The delivery that can be successfully delivered depends on the cost of the delivery of the content items, also known as bidding.

### SUMMARY

In a first aspect of the present disclosure, there is provided a method for delivery cost estimation. The method comprising: extracting first feature information specific to a target recommended content item from related data of the target recommended content item, and the target recommended content item is to be delivered to recommend target resources; at least based on the first feature information, using a trained cost estimation model, determining an expected initial cost in a contending delivery of the target recommended content item; and determining a target initial cost used in the contending delivery of the target recommended content item based on the expected initial cost.

In a second aspect of the present disclosure, there is provided an apparatus for delivery cost estimation. The apparatus comprises: a feature extraction module configured to extract first feature information specific to the target recommended content item from related data of target recommended content item, the target recommended content item to be delivered to recommend a target resources; a cost estimation module configured to determine an expected initial cost in contending delivery of the target recommended content item based on at least the first feature information using a trained cost estimation model; and a target cost determination module configured to determine target initial cost used in the contending delivery of the target recommended content item based on the expected initial cost.

In a third aspect of the present disclosure, there is provided an electronic device. The device comprises: at least one processing unit; and at least one memory, the at least one memory being coupled to the at least one processing unit and storing instructions for execution by the at least one processing unit. The instructions, when executed by at least one processing unit, cause the device to perform the method of the first aspect.

In a fourth aspect of the present disclosure, there is provided a computer-readable storage medium. The medium stores a computer program which, when executed by a processor, implements the method of the first aspect.

It would be appreciated that the content described in the section is neither intended to identify key or essential features of the embodiments of the present disclosure, nor is it intended to limit the scope of the present disclosure. Other features of the present disclosure will be readily envisaged through the following description.

BRIEF DESCRIPTIONS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

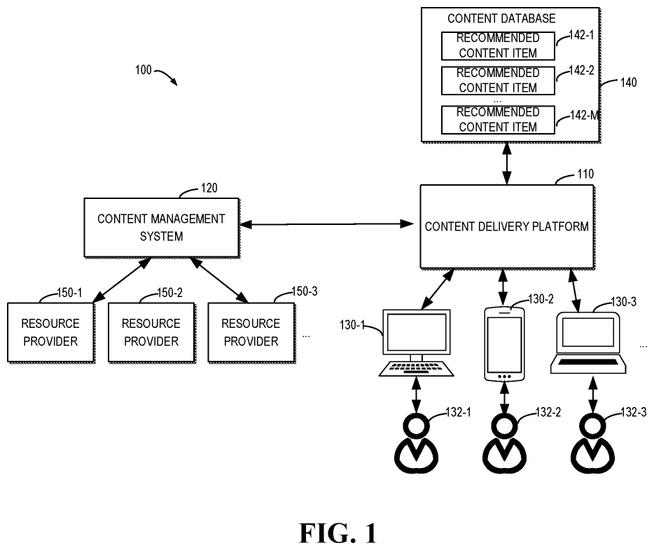

FIG. 1 shows a schematic diagram of an example environment in which embodiments of the present disclosure can be implemented;

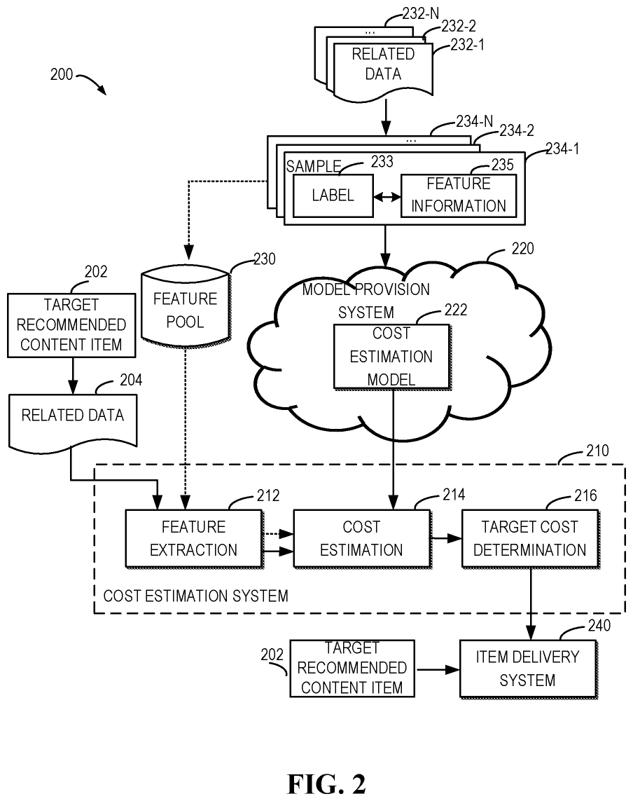

FIG. 2 shows a schematic block diagram of an environment for implementing cost estimation according to some embodiments of the present disclosure;

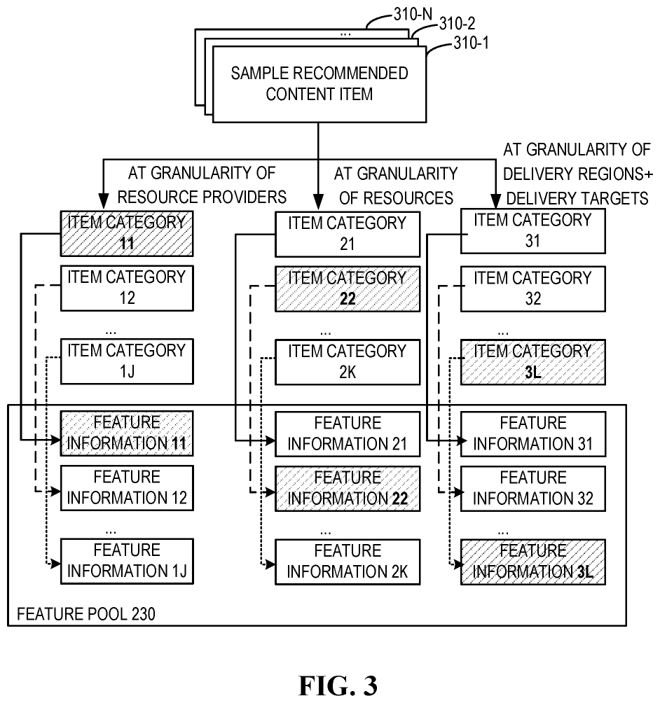

FIG. 3 shows a schematic diagram of off-line features constructed according to some embodiments of the present disclosure;

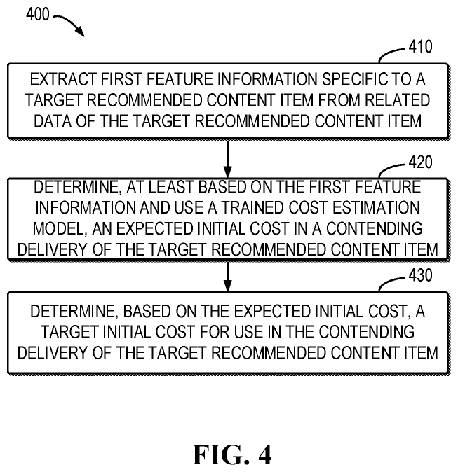

FIG. 4 shows a flowchart of a process for delivery cost estimation according to some embodiments of the present disclosure;

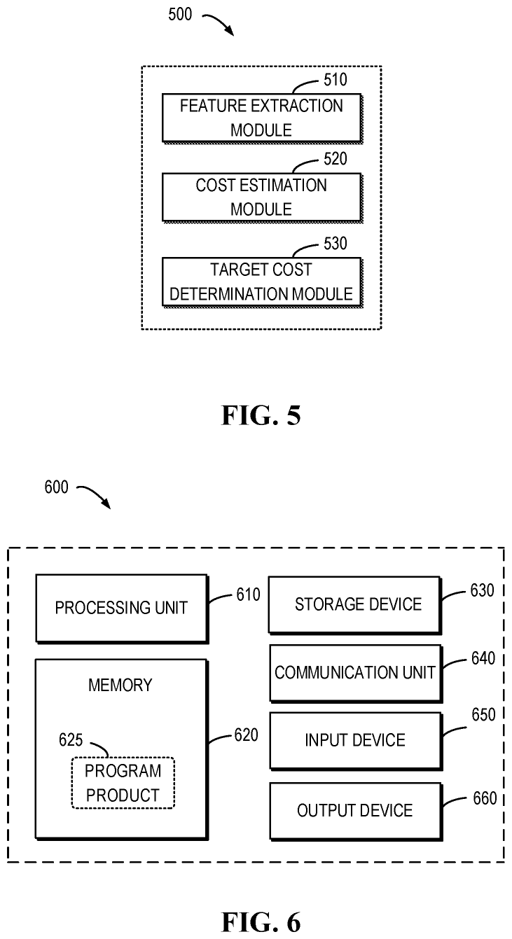

FIG. 5 shows a block diagram of an apparatus for delivery cost estimation according to some embodiments of the present disclosure; and

FIG. 6 shows an electronic device in which one or more embodiments of the present disclosure can be implemented.

### DETAILED DESCRIPTIONS

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

It will be appreciated that the data involved in this technical solution (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

FIG. 1 illustrates a schematic diagram of an example environment 100 in which embodiments of the present disclosure can be implemented. One or more content providers can use Content management system 120 to manage content on Content delivery platform 110. One or more terminal devices 130-1, 130-2, 130-3, etc. (for case of discussion, collectively or individually referred to as terminal devices 130) are associated with content delivery platform 110, and can access various types of content provided on content delivery platform 110 for example, based on corresponding audiences 132-1, 132-2, 132-3, etc. (for case of discussion, collectively or individually referred to as audiences 132). As an example, content delivery platform 110 can be an application, a website, a webpage, or other accessible platform. Terminal device 130 can be installed with applications for accessing content delivery platform 110, or can access content delivery platform 110 in a suitable manner.

CMS 120 can be configured to deliver one or more specific recommended content items related to one or more resources to the audience based on corresponding policies (such as providing or presenting on terminal device 130). The recommended content items to be delivered for example, can include one or more recommended content items 142-1, 142-2, . . . 142-M in the content database 140 (for case of discussion, collectively or individually referred to as recommended content item 142 ).

Resources for example, can include various recommended objects herein, examples of which can include applications, physical goods, virtual goods, audio and video content, and so on. Recommended content items refer to content presented to recommend corresponding resources herein. Examples of recommended content items can include advertisements. The audience group can include one or more audience members, such as audience 132. Audience members can be any potential consumers of resources, such as users, groups, organizations, entities, and so on.

In some embodiments, CMS 120 can distribute corresponding recommended content items on the content delivery platform 110 based on requests from resource providers 150-1, 150-2, 150-3, etc. (for case of discussion, collectively or individually referred to as resource providers 150). In some embodiments, CMS 120 can deliver recommended content items 142 to corresponding audiences 132 on the content delivery platform 110 at least based on requests from various resource providers 150-1, 150-2, 150-3, etc. (for ease of discussion, collectively or individually referred to as resource providers 150). In advertising delivery scenarios, resource providers 150 are sometimes referred to as advertisers. In some embodiments, resource providers may also pay content providers based on the presentation of recommended content items and subsequent conversions.

In some embodiments, CMS 120 may select recommended content items for presentation to a specific terminal device 130 in a content delivery opportunity (e.g., at a specific time and location) of content delivery platform 110 based on bidding results. For example, CMS 120 may receive bids from resource providers 150. In some embodiments, CMS 120 may allocate content delivery opportunities to the highest bidder, which means that the corresponding recommended content item can be successfully delivered in contending delivery. Bid may refer to the cost of contending for a certain recommended content item in a certain content delivery opportunity. A recommended content item that is successfully delivered at a certain cost is called a send, and the cost is called the rank bid for this delivery or send.

In environment 100, terminal device 130 can be any type of mobile terminal, fixed terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDA), audio/video Player, digital cameras/video cameras, positioning devices, television receivers, radio broadcast receivers, e-book devices, gaming devices, or any combination thereof, including accessories and peripherals of these devices or any combination thereof. In some embodiments, terminal device 130 can also support any type of user-specific interface (such as “wearable” circuits, etc.). In environment 100, content delivery platform 110 and/or CMS 120 can be various types of computing systems/servers that can provide computing power, including but not limited to mainframes, edge computing nodes, data centers, cloud computing environments, etc.

It should be appreciated that the structure and function of each element in the environment 100 are described for illustrative purposes only, without implying any limitation on the scope of the present disclosure.

In contending delivery, the initial cost of recommended content items (also known as “initial bid”) can be set first. If the contention fails using the initial cost, the cost (or bid) can be gradually increased. This process of gradually increasing the cost is referred to the price increase process.

The initial cost of a recommended content item has a significant impact on early placement of the content item. If the initial cost is determined to be too high, the recommended content item may be quickly and frequently delivered, gaining a lot of exposure in a short period of time. Moreover, if the resource provider (such as advertisers) has a predetermined budget for each recommended content item, the budget will be quickly spent, which is not expected. On the other hand, if the initial cost is set too low, it will take a period of time to gradually raise the price before successful delivery can be obtained, which will affect the time for the content item to gain exposure.

The overestimation or underestimation of the initial cost is especially unexpected for recommended content items with certain timeliness and short delivery time. For example, live room advertisement is usually delivered during the live to attract users to enter the live room. If users are attracted to enter the live room with the help of short-term exposure of the advertisement, but there is no promotion in the middle and later stages of the live, or promotion is just obtained after a long time since the live began, all these are unexpected. Of course, live room advertisement is only an example here, and there are many other recommended content items with short-term timeliness.

Currently, an evaluation method for calculating the initial cost of recommended content items is with a predetermined formula. Specifically, it is calculated according to the decile of value of eCPM (Expected Cost Per Mile, the expected cost per thousand impressions) of the advertisements that were first launched in the past seven days and the average advertisement coverage rate (PVR) of these advertisements, wherein PVR=ADPV/PV, ADPV (advertisement page view) refers to the number of retrieval requests with advertisements displayed on a specific advertisement space, and PV (page view) refers to the number of retrieval requests for a specific advertisement space. PVR can measure traffic utilization, with a value range of 0-1 (or 0%-100%), where a maximum value of 1 (100%) represents that advertisements will be displayed every time a user browses. The formula for calculating the initial cost is as follows:

$$I n i t B i d = D e c i l e FirstSendEcpm / averagePvr / 1000 \qquad ( 1 )$$

wherein InitBid represents the initial cost, DecileFirstSendEcpm represents the tenth percentile of the eCPM of the considered advertisement, and averagePvr represents the average PVR of the considered advertisement.

The above calculation formula is used to calculate delivery area and delivery target separately. In other words, in the same region and the same delivery target, the initial cost is calculated using past online advertisements separately. For subsequent online advertisements in the same region and the same delivery target, all the same initial bid is used.

However, even the same region and the same delivery target, there are differences in recommended content items (such as advertisements), for example, different resources to be promoted (such as different resource prices) and different delivery budgets. As the delivery target deepens, these differences will become greater. If the budget for a certain recommended content item is very high, but the initial bid is relatively low, resulting in fewer successful delivery times, it will lead to low budget utilization. Therefore, it is expected to provide more accurate and reasonable initial bid estimation, to meet the needs of resource providers for the delivery frequency and delivery time of content items.

In embodiments of the present disclosure, an improved delivery cost estimation solution is proposed. In the solution, based on Machine Learning model to help estimate the initial cost specific to the recommended content item. The feature information of the specific recommended content item is extracted from the related data of the recommended content item and provided to the Machine Learning model for initial bid evaluation. In this way, the initial cost of each recommended content item during contending delivery can be accurately estimated, improving delivery effect and meeting the personalized initial bid requirements of different content items. In addition, experiments prove that this solution can effectively shorten the time for recommended content items to be successfully delivered multiple times (also known as “initiation time”), reduce cold start time, make budget allocation more stable, and improve budget utilization rate.

The following will continue to describe some example embodiments of the present disclosure with reference to the accompanying drawings.

FIG. 2 shows a schematic block diagram of an environment 200 for implementing cost estimation according to some embodiments of the present disclosure. As shown in the figure, the environment 200 involves a cost estimation system 210, a model provisioning system 220, and an item delivery system 240. The cost estimation system 210 can be implemented in the CMS 120 in the environment 100 of FIG. 1, and the item delivery system 240 can be implemented in the content delivery platform 110 and/or the CMS 120. The model provisioning system 220 can be implemented in the CMS 120 or can be implemented independently from the CMS 120.

In FIG. 2, it is assumed that an initial cost to be used in contending delivery is to be determined for a certain recommended content item 142. For discussion, such recommended content item 142 is also referred to as target recommended content item 202. Target recommended content item 202 is to be delivered to recommend target resources. Target resources can be resources provided by the specific resource provider 150, such as applications, physical goods, virtual goods, etc. Contending delivery refers to determining whether the recommended content item has been successfully delivered based on the cost (or bid) given by each recommended content item, such as delivery in delivery opportunities.

Although FIG. 2 shows a single recommended content item, the cost estimation system 210 can be used to perform similar operations on each recommended content item newly launched to be delivered, to give the initial cost of each recommended content item in contending delivery.

The cost estimation system 210 comprises a content extraction subsystem 212, a cost estimation subsystem 214, and a target cost determination subsystem 216. The content extraction subsystem 212 is configured to extract first feature information specific to the target recommended content item 202 from the related data 204 of the target recommended content item 202, and provide the first feature information to the cost estimation subsystem 214. The cost estimation subsystem 214 is configured to use the trained cost estimation model 222 to determine the expected initial cost in the contending delivery of the target recommended content item 202 based on at least the first feature information, and provide the determined expected initial cost to the target cost determination subsystem 216.

The target cost determination subsystem 216 is configured to determine a target initial cost to be used in the contending delivery of the target recommended content item 202 based on the expected initial cost. In some embodiments, the target initial cost may be provided to the item delivery system 240, to use in the delivery process of the target recommended content item 202, such as initially setting the initial delivery cost of the target recommended content item 202 to the determined target initial cost for contending delivery. Of course, according to the actual strategy, in subsequent contending delivery phases, the delivery cost of the target recommended content item 202 may be adjusted as needed.

The cost estimation model 222 can be configured to take at least the feature information specific to the recommended content item as model input and determine the expected initial cost of the recommended content item as model output. In some embodiments, the cost estimation model 222 can be constructed as any suitable Machine Learning model, such as neural networks (NN), decision tree models, classification regression trees (such as CART models, Xgboost regression models, etc.). In embodiments of the present disclosure, there is no limitation on the specific structure of the cost estimation model 222.

Through the training process, the cost estimation model 222 can learn from a large amount of training data how to accurately estimate the initial cost of each recommended content item to be given in contending delivery. The training of the cost estimation model 222 can be implemented in the model provisioning system 220. The training of the model can be an offline process. After the training is completed, the cost estimation model 222 can be provided to the cost estimation system 210 for online use.

The first feature information specific to the target recommended content item 202 can be used to represent the target recommended content item 202. The first feature information can be unique to each recommended content item. The first feature information can be represented in the form of a multidimensional vector. Feature information is sometimes referred to as feature vectors, feature representations, vector representations, embedded representations, and so on.

The related data 204 for extracting the first feature information may include various types of data related to the target recommended content item 202. In some embodiments, the related data 204 of the target recommended content item 202 may include a target delivery plan of the target recommended content item, which may indicate at least one of the following: delivery target (e.g., the audience of the recommended content item), delivery contending mode (e.g., bidding mode), delivery budget, the set delivery duration, delivery start time, etc. In some embodiments, the related data 204 of the target recommended content item 202 may additionally or alternatively include resource related data of the target resource, wherein the resource related data 204 may include attribute information related to one or more aspects of the target resource, such as resource type, provider, industry information, appearance information, price, review information, rating information, etc. One or more of the related data 204 can be converted into vectors and can be cascaded or mapped in a predetermined manner to the first feature information specific to the target recommended content item 202.

In some embodiments, aside from using feature information specific to the recommended content item, other feature information can also be used to make the cost estimation model 222 perform more accurate and reasonable initial cost estimation. In particular, some feature information can be extracted or counted in advance from the related data of historical recommended content items (also referred to as sample recommended content items) that have been successfully delivered. These sample recommended content items can be divided according to classification criteria of one or a plurality of granularities, and a plurality of item categories can be set under each classification criteria of granularity. In this way, for each classification criteria of granularity, second feature information can be extracted from the related data of the sample recommended content item in each item category that is divided into a plurality of item categories, as the second feature information specific to the item category. The second feature information can belong to offline features and is pre-determined based on the sample recommended content items that have been delivered. The second feature information specific to each item category can be stored in feature pool 230.

FIG. 3 shows a schematic diagram of offline feature construction according to some embodiments of the present disclosure. As shown in FIG. 3, N (N is an integer greater than 1) sample recommended content items 310-1, 310-2, . . . 310-N (for case of discussion, sometimes collectively referred to as or individually referred to as sample recommended content item 310) can be obtained to determine the second feature information specific to the item category.

In some embodiments, as previously mentioned, the sample recommended content item 310 is the sample recommended content item that has been successfully delivered. In addition, in order to improve the representation ability of the second feature information, the sample recommended content item 310 can be a historical recommended content item that has been successfully delivered more than a predetermined threshold value. The predetermined threshold value can be set according to the actual application, such as 300 times, 500 times, 700 times, etc. In some embodiments, recommended content items that have been successfully delivered more than a predetermined threshold value can be selected from recommended content items that have been delivered in the most recent period of time as sample recommended content item 310, and recommended content items that have been delivered less than the threshold value are filtered out.

In the example of FIG. 3, for the purpose of discussion, it is assumed that according to the classification criteria of granularity of the resource provider (advertiser), granularity of resource, and granularity of delivery area+delivery target, N sample recommended content items 310 are divided into multiple item categories at these three granularities.

Specifically, the granularity of the resource provider refers to the delivery side of the sample recommended content item 310. For example, for live room advertisement, the advertiser can be a live room host or an operator of the live room; for commodity advertisement, the advertiser can be a merchant of the commodity, and so on. In FIG. 3, according to the classification criteria of the granularity of the resource provider, N sample recommended content items 310 can be divided into J item categories based on the type of the resource provider, namely item category 11, item category 12, . . . item category 1J.

Resource granularity refers to the resources that the sample recommended content item 310 wants to promote. For example, for live room advertisements, the resources can be live room; for commodity advertisements, the resources can be the commodity to be promoted, and so on. In FIG. 3, according to the classification criteria of resource granularity, N sample recommended content items 310 can be divided into K item categories based on the type of resources, namely item category 21, item category 22, . . . item category 2K.

The granularity of delivery area and delivery target refer to the area and target that the sample recommended content item 310 wants to deliver, wherein the delivery target can be for example, the expected audience of the sample recommended content item. The delivery area and delivery target can be set by the resource provider or automatically recommended. In FIG. 3, according to the classification criteria of the granularity of delivery area and delivery target, N sample recommended content items 310 with different delivery areas and different delivery targets can be divided into L item categories, namely item category 31, item category 32, . . . item category 3L.

It would be appreciated that the number of item categories divided at each granularity (e.g., J, K, L) can be determined according to an actual application and the specific sample recommended content items used, and the present disclosure is not limited to this. In addition, it would also be appreciated that the three granularities given in FIG. 3 are only examples, and more (e.g., more than three granularities), fewer (e.g., one or two granularities), or different classification criteria corresponding to different granularities can be set according to actual application needs to divide sample recommended content items.

In some embodiments, for each item category at each granularity, the second feature information specific to the item category can be determined based on the related data of a plurality of sample recommended content items 310 that are divided into the item category. As shown in FIG. 3, at the granularity of resource provider, the feature information 11, 12, . . . 1J corresponding to each of the J item categories can be extracted; at the granularity of resource, the feature information 21, 22, . . . 2K corresponding to each of the K item categories can be extracted; at the granularity of delivery area and delivery target, the feature information 31, 32, . . . 3L corresponding to each of the L item categories can be extracted.

In some embodiments, the second feature information specific to a certain item category can be determined based on statistical information of the related data of a plurality of sample recommended content items 310 under the item category. In some embodiments, the related data of the sample recommended content item 310 used to extract the second feature information can include the delivery plan of the sample recommended content item 310. For a certain item category, the number of plans of sample recommended content items 310 in the item category can be counted as at least a part of the second feature information. Alternatively or additionally, the related data of the considered sample recommended content item 310 can include the cost when the sample recommended content item 310 is successfully delivered (e.g., rank bid). For a certain item category, statistical values such as percentiles (e.g., deciles), mean, and/or variance, etc. of the cost of the sample recommended content item 310 in the item category can be counted as at least a part of the second feature information. Alternatively or additionally, the related data of the considered sample recommended content item 310 can include the traffic utilization rate when the sample recommended content item 310 is successfully delivered, such as PVR (wherein PVR=ADPV/PV). For a certain item category, statistical values such as percentiles (e.g., deciles), mean, variance, etc. of the traffic utilization rate of the sample recommended content item 310 in the item category can be counted as at least part of the second feature information. Alternatively or additionally, the related data of the considered sample recommended content item 310 can include the return rate when the sample recommended content item 310 is successfully delivered, such as ECPM. For a certain item category, statistical values such as percentiles (e.g., deciles), mean, variance, etc. of the return rate of the sample recommended content item 310 in the item category can be counted as at least part of the second feature information.

Of course, the above provides some examples of related data and the second feature information that can be extracted. In fact, more, less, or different related data can also be used and more, less, or different feature information can be extracted according to actual application needs. The related data of sample recommended content items can be obtained from various sources, such as bid logs and delivery logs of sample recommended content items. The embodiments of the present disclosure are not limited in this aspect.

After extracting the second feature information for different item categories with different granularities, these second feature information can be stored in the feature pool 230. When using the cost estimation model 222 to estimate the initial cost of the target recommended content item 202, the item category to which the target recommended content item 202 is divided at each granularity can be determined. For example, in FIG. 3, it is assumed that the target recommended content item 202 is divided into item categories 11, 22, and 3L at three example granularities. In this way, the second feature information specific to the item category to which the target recommended content item 202 is divided can be obtained from the feature pool 230. For example, in FIG. 3, feature information 11 specific to item category 11, feature information 22 specific to item category 22, and feature information 3L specific to item category 3L can be obtained.

The initial cost estimation of the target recommended content item 202 can be performed using the cost estimation model 222 based on the first feature information specific to the target recommended content item 202 and the second feature information specific to the item category to which the target recommended content item 202 is divided. The extracted first feature information and second feature information are input as model inputs of the cost estimation model 222. The cost estimation model 222 can more accurately and reasonably determine the expected initial cost of the target recommended content item 202 from the feature information representing the target recommended content item 202 and the feature information of the sample recommended content item that is related to the target recommended content item 202 and successfully delivered.

In this way, the determined initial cost can be expected not only to meet the personalized requirements of the target recommended content item 202, but also to ensure that the target recommended content item 202 is evenly and continuously delivered within the range of budget, so that the target resource can obtain effective exposure and improve delivery effect.

The above discussed the use of a trained cost estimation model 222 to perform initial cost estimation. Continuing to return to reference to FIG. 2, the training process of the cost estimation model 222 is described. The model provisioning system 222 can be configured to perform training on the cost estimation model 222. The training of the cost estimation model 222 can be based on samples 234-1, 234-2, . . . 234-N (for case of discussion, collectively or individually referred to as sample 234, wherein N is an integer greater than or equals to 1). Each sample includes a label 233 and feature information 235, wherein the feature information 235 is used as the model input for training the cost estimation model 222, the label 233 is used as ground-truth model output for training the cost estimation model 222. N samples 234 can be based on related data 232-1, 232-2, . . . 232-N (for case of discussion, collectively or individually referred to as related data 232) of N sample recommended content items.

In some embodiments, the N sample recommended content items may be the sample recommended content item 310 described above with respect to FIG. 3. The feature information 235 in the sample 234 may include first feature information specific to the sample recommended content item and second feature information specific to the item category to which the sample recommended content item is divided. That is to say, after collecting the N sample recommended content items, divide these sample recommended content items into different item categories at different granularities, and extract second feature information specific to the item category. On the one hand this second feature information is used for training the cost estimation model 222, on the other hand are also stored in the feature pool 230 to provide to be used in applying the model for cost estimation. The first feature information and the second feature information extracted for the sample recommended content item during model training are similar to the first feature information and the second feature information extracted for the target recommended content item described above, and the related data used is also similar, which will not be repeated here.

In some embodiments, the label 233 of each sample 234 can indicate the ground-truth initial cost of the corresponding sample recommended content item. In some embodiments, the ground-truth initial cost of each sample recommended content item can be determined based on a plurality of costs (such as rank bid) of the sample recommended content item when successfully delivered a plurality of times. For example, a certain percentile (such as 10 percentiles or other percentiles) of the plurality of costs of each sample recommended content item can be taken as the label 233. The calculated initial cost is generally considered to be more in line with expectations and can therefore be output as the ground-truth (i.e., true initial cost) in model training. In this way, the cost estimation model 222 will learn to be able to predict the initial cost indicated by the label 233 as much as possible based on the model input (first feature information and second feature information).

Various model training techniques can be used to train the model, including but not limited to Xgboost regression training. During training, the parameter values of the model can be updated by constructing training objectives (such as training objectives based on loss function) and through algorithms such as random layer descent. The model parameter values can be continuously updated until the training objectives are achieved, such as minimizing or reducing the loss function to the expected value, or updating the number of iterations to a predetermined number, etc.

After the model training is completed, the trained cost estimation model 222 can respond to an estimation request from the cost estimation system 210 for performing an initial cost estimation for the target recommended content item.

In some embodiments, the cost estimation model 222 can also be continuously updated after the first training is completed, for example, updating at predetermined time intervals (such as daily, weekly, monthly, etc.). At each update, new sample recommended content items can be collected to construct training samples for retraining or fine-tuning the cost estimation model 222. In some embodiments, the newly collected sample recommended content items can also be used to continuously update the feature information of each item category in the feature pool 230. In this way, the cost estimation model 222 can capture new features that may appear in the contending delivery of recommended content items, and then adjust the cost estimation process to provide more accurate and reasonable estimated initial costs for subsequent target recommended items. Correspondingly, the second feature information specific to each item category in the feature pool 230 can also be updated to reflect the overall feature of the sample recommended content items in each item category that have been successfully delivered recently. In some embodiments, depending on the additional sample recommended content items obtained, new item categories and corresponding second feature information can also be added in the update of the second feature information.

As previously mentioned, the estimated initial cost output by the cost estimation model 222 for the target recommended content item 202 may be used by a target cost determination subsystem 216 for the target initial cost to be used in contending delivery. In some embodiments, the estimated initial cost output by the model may be used directly as the target initial cost.

In some embodiments, a predetermined adjustment coefficient may be set to adjust the cost estimation model 222 to output the expected initial cost, avoiding the cost estimation model 222 being underestimated or overestimated, in order to balance between the target recommended content item 142 being frequently delivered and cannot being delivered. The adjustment coefficient may be set to a value of 0-1 (for cases that may be overestimated) or greater than 1 (for cases that may be underestimated). The target cost determination subsystem 216 may determine the target initial cost based on the adjusted expected initial cost.

In some embodiments, the target cost determination subsystem 216 may also determine an initial cost upper limit and an initial cost lower limit for the target recommended content item 142, and cause the determined target initial cost to be determined between the initial cost upper limit and the initial cost lower limit. In some embodiments, another expected initial cost of the target recommended content item may also be determined using conventional policy-based manners (e.g., based on the above formula (1) or other policies based on fixed rules), and the target initial cost of the target recommended content item may be jointly determined based on the other initial cost. In some embodiments, the target initial cost of the target recommended content item may be determined as follows:

$$InitBid = max ( StrategyInitBid * CapLowerBound , min ( StrategyInitBid * CapUpperBound , ModelInitBid * coef ) ) \qquad ( 2 )$$

wherein InitBid represents the target initial cost, StrategyInitBid represents the expected initial cost determined using conventional policy-based manners, ModelInitBid represents the expected initial cost determined using cost estimation model 222, coef represents the adjustment coefficient, CapLowerBound represents the initial cost lower limit scaling coefficient, and CapUpperBound represents the initial cost upper limit scaling coefficient. According to the above formula (2), if the adjusted expected initial cost ModelInitBid*coef exceeds StrategyInitBid*CapUpperBound or is lower than StrategyInitBid*CapLowerBound, then the target initial cost can be determined as the initial cost upper limit or the initial cost lower limit. If the adjusted expected initial cost ModelInitBid*coef is within a reasonable range, then the target initial cost is determined as the adjusted expected initial cost ModelInitBid*coef.

FIG. 4 shows a flowchart of a process 400 of delivery cost estimation according to some embodiments of the present disclosure. The process 400 can be implemented at the cost estimation system 210 of FIG. 2.

At block 410, the cost estimation system 210 extracts first feature information specific to a target recommended content item from related data of the target recommended content item. The target recommended content item is to be delivered to recommend a target resource.

At block 420, the cost estimation system 210 determines, at least based on the first feature information and using a trained cost estimation model, an expected initial cost in a contending delivery of the target recommended content item.

At block 430, the cost estimation system 210 determines, based on the expected initial cost, a target initial cost for use in the contending delivery of the target recommended content item.

In some embodiments, determining the expected initial cost comprises: obtaining second feature information specific to at least one item category, the target recommended content item being divided into the at least one item category, and second feature information specific to an item category being determined based on related data of a plurality of sample recommended content items divided into the item category; and determining the expected initial cost based on the first feature information and the second feature information and using the cost estimation model.

In some embodiments, the at least one item category comprises a plurality of item categories, and the recommended content item is divided into the plurality of item categories according to classification criteria of a plurality of granularities.

In some embodiments, the related data for the plurality of sample recommended content items comprises at least one of the following: respective delivery plans of the plurality of sample recommended content items, respective costs when the plurality of sample recommended content items are successfully delivered, respective traffic utilization rates when the plurality of sample recommended content items are successfully delivered, or respective return rates when the plurality of sample recommended content items are successfully delivered.

In some embodiments, related data of the target recommended content item comprises at least one of a target delivery plan of the target recommended content item or resource related data of the target resource. In some embodiments, the target delivery plan indicates at least one of the following: a delivery target, a delivery competition mode, a delivery budget, a delivery duration, or a delivery start time.

In some embodiments, determining the target initial cost comprises: adjusting the expected initial cost using a predetermined adjustment coefficient, to obtain adjusted expected initial cost; and determining the target initial cost based on the adjusted expected initial cost.

In some embodiments, determining the target initial cost comprises: determining an initial cost upper limit and an initial cost lower limit for the target recommended content item; and determining the target initial cost based on the expected initial cost, such that the target initial cost is between the initial cost upper limit and the initial cost lower limit.

In some embodiments, the cost estimation model is trained based on a plurality of sample recommended content items and respective ground-truth initial costs of the plurality of sample recommended content items, a number of times of the plurality of sample recommended content items being successful delivered respectively exceeding a predetermined threshold, and a respective ground-truth initial cost of a sample recommended content item being determined based on a cost of the sample recommended content item when being successfully delivered.

FIG. 5 shows a block diagram of an apparatus for delivery cost estimation according to some embodiments of the present disclosure. An apparatus 500 may be implemented as or included in the cost estimation system 210. Various modules/components in the apparatus 500 may be implemented by hardware, software, firmware, or any combination thereof.

As shown in the figure, the apparatus 500 comprises a feature extraction module 510 configured to extract first feature information specific to the target recommended content item from related data of target recommended content item. The target recommended content item is to be delivered to recommend a target resource. The apparatus 500 also comprises a cost estimation module 520 configured to determine, at least based on the first feature information, and using a trained cost estimation model, an expected initial cost in a contending delivery of the target recommended content item. The apparatus 500 also comprises a target cost determination module 530 configured to determine, based on the expected initial cost, a target initial cost for use in the contending delivery of the target recommended content item.

In some embodiments, the cost estimation module 520 comprises: a feature obtaining module configured to obtain second feature information specific to at least one item category, the target recommended content item being divided into the at least one item category, and second feature information specific to an item category being determined based on related data of a plurality of sample recommended content items divided into the item category; and a cost estimation module based on two features configured to determine the expected initial cost based on the first feature information and the second feature information, and using the cost estimation model.

In some embodiments, the at least one item category comprises a plurality of item categories, and the recommended content item is divided into the plurality of item categories according to classification criteria of a plurality of granularities.

In some embodiments, the related data for the plurality of sample recommended content items comprises at least one of the following: respective delivery plans of the plurality of sample recommended content items, respective costs when the plurality of sample recommended content items are successfully delivered, respective traffic utilization rates when the plurality of sample recommended content items are successfully delivered, or respective return rates when the plurality of sample recommended content items are successfully delivered.

In some embodiments, related data of the target recommended content item comprises at least one of a target delivery plan of the target recommended content item or resource related data of the target resource. In some embodiments, the target delivery plan indicates at least one of the following: a delivery target, a delivery competition mode, a delivery budget, a delivery duration, or a delivery start time.

In some embodiments, the target cost determination module 530 comprises: an adjustment module configured to adjust the expected initial cost using a predetermined adjustment coefficient, to obtain adjusted expected initial cost; and a target cost determination module based on the adjustment, configured to determine the target initial cost based on the adjusted expected initial cost.

In some embodiments, the target cost determination module 530 comprises: an upper and lower limit determination module configured to determine an initial cost upper limit and an initial cost lower limit for the target recommended content item; and a target cost determination module based on upper and lower limits, configured to determine the target initial cost based on the expected initial cost, such that the target initial cost is between the initial cost upper limit and the initial cost lower limit.

In some embodiments, the cost estimation model is trained based on a plurality of sample recommended content items and respective ground-truth initial costs of the plurality of sample recommended content items, a number of times of the plurality of sample recommended content items being successfully delivered respectively exceeding a predetermined threshold, and a respective ground-truth initial cost of a sample recommended content items being determined based on a cost of the sample recommended content item when being successfully delivered.

FIG. 6 shows a block diagram of an electronic device 600 in which one or more embodiments of the present disclosure can be implemented. It would be appreciated that the electronic device 600 shown in FIG. 6 is only an example and should not constitute any restriction on the function and scope of the embodiments described herein. The electronic device 600 shown in FIG. 6 may be used to implement the CMS 120 and/or information delivery platform 110 of FIG. 1, the cost estimation system 210, the model supply system 220, and/or the project delivery system 240 of FIG. 2. The electronic device 600 shown in FIG. 6 may be used to implement the apparatus 500 of FIG. 5.

As shown in FIG. 6, the electronic device 600 is in the form of a general computing device. The components of the electronic device 600 may include, but are not limited to, one or more processors or processing units 610, a memory 620, a storage devices 630, one or more communication units 640, one or more input devices 650, and one or more output devices 660. The processing unit 610 may be an actual or virtual processors and can execute various processes according to the programs stored in the memory 620. In a multiprocessor system, multiple processing units execute computer executable instructions in parallel to improve the parallel processing capability of the electronic device 600.

The electronic device 600 typically includes a variety of computer storage media. Such media may be any available media that is accessible to the electronic device 600, including but not limited to volatile and non-volatile media, removable and non-removable media. The memory 620 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 630 may be any removable or non-removable medium, and may include a machine-readable medium, such as a flash drive, a disk, or any other medium, which can be used to store information and/or data (such as training data for training) and can be accessed within electronic device 600.

The electronic device 600 may further include additional removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces.

In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method for delivery cost estimation, comprising:
extracting first feature information specific to a target recommended content item from related data of the target recommended content item, the target recommended content item being to be delivered to recommend a target resource;
determining, at least based on the first feature information and using a trained cost estimation model, an expected initial cost in a contending delivery of the target recommended content item; and
determining, based on the expected initial cost, a target initial cost for use in the contending delivery of the target recommended content item.

2. The method of claim 1, wherein determining the expected initial cost comprises:
obtaining second feature information specific to at least one item category, the target recommended content item being divided into the at least one item category, and second feature information specific to an item category being determined based on related data of a plurality of sample recommended content items divided into the item category; and
determining the expected initial cost based on the first feature information and the second feature information and using the cost estimation model.

3. The method of claim 2, wherein the at least one item category comprises a plurality of item categories, and the recommended content item is divided into the plurality of item categories according to classification criteria of a plurality of granularities.

4. The method of claim 2, wherein the related data for the plurality of sample recommended content items comprises at least one of the following:
respective delivery plans of the plurality of sample recommended content items,
respective costs when the plurality of sample recommended content items are successfully delivered,
respective traffic utilization rates when the plurality of sample recommended content items are successfully delivered, or
respective return rates when the plurality of sample recommended content items are successfully delivered.

5. The method of claim 1, wherein the related data of the target recommended content item comprises at least one of a target delivery plan of the target recommended content item or resource related data of the target resource, and
wherein the target delivery plan indicates at least one of the following: a delivery target, a delivery competition mode, a delivery budget, a delivery duration, or a delivery start time.

6. The method of claim 1, wherein determining the target initial cost comprises:
adjusting the expected initial cost using a predetermined adjustment coefficient, to obtain adjusted expected initial cost; and
determining the target initial cost based on the adjusted expected initial cost.

7. The method of claim 1, wherein determining the target initial cost comprises:
determining an initial cost upper limit and an initial cost lower limit for the target recommended content item; and
determining the target initial cost based on the expected initial cost, such that the target initial cost is between the initial cost upper limit and the initial cost lower limit.

8. The method of claim 1, wherein the cost estimation model is trained based on a plurality of sample recommended content items and respective ground-truth initial costs of the plurality of sample recommended content items, a number of times of the plurality of sample recommended content items being successfully delivered respectively exceeding a predetermined threshold, and a respective ground-truth initial cost of a sample recommended content item being determined based on a cost of the sample recommended content item when being successfully delivered.

9. An electronic device comprising:
at least one processing unit; and
at least one memory, the at least one memory being coupled to the at least one processing unit and storing instructions for execution by the at least one processing unit, the instructions, when executed by the at least one processing unit, causing the device to perform acts comprising:
extracting first feature information specific to a target recommended content item from related data of the target recommended content item, the target recommended content item being to be delivered to recommend a target resource;
determining, at least based on the first feature information and using a trained cost estimation model, an expected initial cost in a contending delivery of the target recommended content item; and
determining, based on the expected initial cost, a target initial cost for use in the contending delivery of the target recommended content item.

10. The device of claim 9, wherein determining the expected initial cost comprises:
obtaining second feature information specific to at least one item category, the target recommended content item being divided into the at least one item category, and second feature information specific to an item category being determined based on related data of a plurality of sample recommended content items divided into the item category; and
determining the expected initial cost based on the first feature information and the second feature information and using the cost estimation model.

11. The device of claim 10, wherein the at least one item category comprises a plurality of item categories, and the recommended content item is divided into the plurality of item categories according to classification criteria of a plurality of granularities.

12. The device of claim 10, wherein the related data for the plurality of sample recommended content items comprises at least one of the following:
respective delivery plans of the plurality of sample recommended content items,
respective costs when the plurality of sample recommended content items are successfully delivered,
respective traffic utilization rates when the plurality of sample recommended content items are successfully delivered, or
respective return rates when the plurality of sample recommended content items are successfully delivered.

13. The device of claim 9, wherein the related data of the target recommended content item comprises at least one of a target delivery plan of the target recommended content item or resource related data of the target resource, and
wherein the target delivery plan indicates at least one of the following: a delivery target, a delivery competition mode, a delivery budget, a delivery duration, or a delivery start time.

14. The device of claim 9, wherein determining the target initial cost comprises:
adjusting the expected initial cost using a predetermined adjustment coefficient, to obtain adjusted expected initial cost; and
determining the target initial cost based on the adjusted expected initial cost.

15. The device of claim 9, wherein determining the target initial cost comprises:
determining an initial cost upper limit and an initial cost lower limit for the target recommended content item; and
determining the target initial cost based on the expected initial cost, such that the target initial cost is between the initial cost upper limit and the initial cost lower limit.

16. The device of claim 9, wherein the cost estimation model is trained based on a plurality of sample recommended content items and respective ground-truth initial costs of the plurality of sample recommended content items, a number of times of the plurality of sample recommended content items being successfully delivered respectively exceeding a predetermined threshold, and a respective ground-truth initial cost of a sample recommended content item being determined based on a cost of the sample recommended content item when being successfully delivered.

17. A computer readable storage medium having a computer program stored thereon which, when executed by an electronic device, cause the electronic device to perform acts comprising:
extracting first feature information specific to a target recommended content item from related data of the target recommended content item, the target recommended content item being to be delivered to recommend a target resource;
determining, at least based on the first feature information and using a trained cost estimation model, an expected initial cost in a contending delivery of the target recommended content item; and
determining, based on the expected initial cost, a target initial cost for use in the contending delivery of the target recommended content item.

18. The device of claim 17, wherein determining the expected initial cost comprises:
obtaining second feature information specific to at least one item category, the target recommended content item being divided into the at least one item category, and second feature information specific to an item category being determined based on related data of a plurality of sample recommended content items divided into the item category; and
determining the expected initial cost based on the first feature information and the second feature information and using the cost estimation model.

19. The device of claim 17, wherein determining the target initial cost comprises:
adjusting the expected initial cost using a predetermined adjustment coefficient, to obtain adjusted expected initial cost; and
determining the target initial cost based on the adjusted expected initial cost.

20. The device of claim 17, wherein determining the target initial cost comprises:
determining an initial cost upper limit and an initial cost lower limit for the target recommended content item; and
determining the target initial cost based on the expected initial cost, such that the target initial cost is between the initial cost upper limit and the initial cost lower limit.
